(19) United States
(12) Patent Application Publication
(10) Pub. No.: US 2005/0117098 A1
(43) Pub. Date: Jun. 2, 2005

(54) Liquid crystal display and electronic device

(75) Inventor: Hayato Kurasawa, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/972,438

(22) Filed: Oct. 26, 2004

(30) Foreign Application Priority Data
Nov. 6, 2003 (JP) 2003-377173

(51) Int. Cl. G02F 1/1335

(52) U.S. Cl. 349/114

(57) ABSTRACT

Aspects of the invention can provide a liquid crystal display capable of eliminating or reducing the irregularity of the orientation of liquid crystal in an inclined region in a multi-gap structure. The liquid crystal display can include a pair of substrates with a liquid crystal layer interposed therebetween, the liquid crystal layer having negative dielectric anisotropy. In the liquid crystal display, a dot region can include a transmission display section and a reflection display section. Disposed between the a substrate and the liquid crystal layer is a bank layer for making the thickness of the liquid crystal layer in the reflection display section smaller than that of the liquid crystal layer in the transmission display section. A protrusion for initially tilting the orientation of liquid crystal can be disposed between the substrate and the liquid crystal layer in the transmission display section. The height of the protrusion can be larger than that of the bank layer in the reflection display section.

### BACKGROUND OF THE INVENTION

1. Field of Invention

Aspects of the invention can relate to a liquid crystal display and an electronic device.

2. Description of Related Art

A related art transreflective liquid crystal display with a reflection mode and a transmission mode can have one type of liquid crystal display having a liquid crystal layer between a top substrate and a bottom substrate. A transreflective liquid crystal display including a reflective film on an inner surface of the bottom substrate has been proposed. The reflective film can be composed of metal, such as aluminum, and has a window for transmitting light. The reflective film is used for transreflective display. In reflection mode, external light from above the top substrate passes through the liquid crystal layer and is reflected by the reflective film on the bottom substrate. The reflected light passes through the liquid crystal layer again and is emitted from the top substrate for display. In transmission mode, light from a backlight provided on the bottom substrate side passes through the window of the reflective film and the liquid crystal layer and is emitted from the top substrate for display. In the reflective film, a region where the window is formed is a transmission display section and a region excluding the window is a reflection display section.

Unfortunately, related art transreflective liquid crystal displays suffer from a problem of having small viewing angles in transmission display. This is because, in the transreflective liquid crystal display, the reflective plate for transreflective display is disposed on the inner surface of a liquid crystal cell for preventing parallax so that reflection display is performed using a single polarizer disposed on the viewer's side, and thus flexibility of the optical design is small. To address this problem, Jisaki et al. proposed a novel liquid crystal display utilizing vertical alignment liquid crystal in Development of transflective LCD for high contrast and wide viewing angle by using homeotropic alignment”, M. Jisaki et al., Asia Display/IDW'01, p. 133-136 (2001) specified below. The features of this related art liquid crystal display are listed as follows:

(1) Application of a vertical alignment (VA) mode in which liquid crystal with negative dielectric anisotropy is aligned perpendicular to a substrate and is tilted when a voltage is applied.

(2) Application of a multi-gap structure where the thickness of the liquid crystal layer (cell gap) in the transmission display section is different from that of the reflection display section (See, for example, Japanese Unexamined Patent Application Publication No. Hei 11-242226).

(3) Application of a divided-alignment structure in which the transmission display section is a regular octahedron and a protrusion is disposed in the center of the transmission display section on a color-filter (CF) substrate such that the liquid crystal is tilted in eight directions in the transmission display section.

Application of the multi-gap structure described in Japanese Unexamined Patent Application Publication No. Hei 11-242226 to the transreflective liquid crystal display is very effective because in the liquid crystal layer, the transmission display section transmits incident light once but the reflection display section transmits incident light twice so that retardation (phase difference) in the transmission display section differs from that in the reflection display section. Adjustment of the difference in retardation through the multi-gap structure makes the transmittance in the transmission display section and the reflection display section homogeneous, leading to superior display quality.

When the protrusion for controlling the alignment of liquid crystal molecules is not provided, the liquid crystal molecules are randomly tilted when a voltage is applied. Therefore, the occurrence of discontinuous lines (disclinations) at the boundaries of regions of liquid crystal with different orientation creates afterimages or the like. The regions of liquid crystal with different orientation have different viewing angles so that unevenness of display with rough spots is perceived when the display is viewed from an oblique direction. By contrast, when the protrusion is provided, as described, for example, in Japanese Unexamined Patent Application Publication No. Hei 11-242226, the liquid crystal molecules are aligned in a predetermined direction when an electric field is applied. Accordingly, the liquid crystal display attains a wide viewing angle and excellent display quality.

### SUMMARY OF THE INVENTION

Although the protrusion controls the tilted direction of the liquid crystal molecules in the transmission display section in Jisaki et al., there is no description concerning the tilted direction of the liquid crystal molecules in the reflection display section. The reflection display section also suffers from afterimages due to the occurrence of discontinuous lines (disclinations) at the boundaries of regions of liquid crystal with different orientation. The regions of liquid crystal with different orientation have different viewing angles so that unevenness of display with rough spots is perceived when the display is viewed from an oblique direction.

In the multi-gap structure, an inclined region is disposed in the border region between the transmission display section and the reflection display section. The inclined region prevents the alignment control of the protrusion disposed in the transmission display section so that liquid crystal is randomly aligned in the inclined region in the multi-gap structure, resulting in irregular orientation of the liquid crystal display in the inclined region. This can make it difficult to control the alignment of the liquid crystal in the reflective display section so that symmetry of the orientation of liquid crystal in a pixel is greatly disturbed. The irregularity of the orientation of the liquid crystal causes the occurrence of the unevenness of display with rough spots.

Aspects of the invention can provide a liquid crystal display capable of eliminating the irregular orientation of liquid crystal in the inclined region in the multi-gap structure and to provide a high quality electronic device with homogeneous display.

According to a first aspect of the invention, a liquid crystal display can include a pair of substrates, a liquid crystal layer interposed between the pair of substrates, the liquid crystal layer being composed of liquid crystal that has negative dielectric anisotropy and is initially aligned perpendicular to the substrates, and dot regions, each including a transmission display section and a reflection display section. In the liquid crystal display, a bank layer is disposed between at least one of the substrates and the liquid crystal layer, the bank layer making the thickness of the liquid crystal layer in the reflection display section smaller than the thickness of the liquid crystal layer in the transmission display section. Furthermore, in the liquid crystal display, a protrusion is disposed between at least one of the substrates and the liquid crystal layer in the transmission display section of each dot region, the protrusion initially tilting the orientation of the liquid crystal, and the thickness of the liquid crystal layer in a region where the protrusion is disposed is smaller than the thickness of the liquid crystal layer in the reflection display section.

Since the protrusion for initially tilting the orientation of the liquid crystal is disposed, the liquid crystal molecules can be tilted in a predetermined direction in the transmission display section. Furthermore, since the thickness of the liquid crystal layer in a region where the protrusion is disposed is smaller than the thickness of the liquid crystal layer in the reflection display section, the liquid crystal molecules in the vicinity of the inclined region of the bank layer can be tilted in a predetermined direction, similar to a domino toppling. The irregularity of the orientation of the liquid crystal is eliminated in the inclined region in the multi-gap structure. Since the liquid crystal molecules in the reflection display section can be tilted in a predetermined direction, like a domino toppling, the orientation of the liquid crystal molecules can be controlled over the entire liquid crystal layer. Accordingly, unevenness of display with rough spots can be prevented, leading to a high quality display.

In the liquid crystal display according to the first aspect of the invention, preferably the height of the protrusion is larger than the height of the bank layer disposed in the reflection display section. Accordingly, the thickness of the liquid crystal layer in a region where the protrusion is disposed is smaller than the thickness of the liquid crystal layer in the reflection display section. Thus, the liquid crystal display exhibits the aforementioned effects.

In the liquid crystal display according to the first aspect of the invention, preferably the bank layer includes an inclined region, the inclined region being disposed in the border region between the transmission display section and the reflection display section, and the protrusion includes an inclined surface, the inclination angle of the inclined surface being larger than the inclination angle of the inclined region of the bank layer. As the inclination angle of the inclined surface in the protrusion increases, the orientation control over the liquid crystal molecules becomes superior. By making the inclination angle of the inclined surface in the protrusion larger than the inclination angle of the inclined region of the bank layer, all the liquid crystal molecules in the vicinity of the inclined region can be tilted in a predetermined direction. Hence, the irregularity of the orientation of the liquid crystal is eliminated in the inclined region in the multi-gap structure.

In the liquid crystal display according to the first aspect of the invention, preferably one of the substrates includes the bank layer and the protrusion. Accordingly, the protrusion and the bank layer are disposed in predetermined relative positions, thereby ensuring the relative orientation of the liquid crystal in a pixel.

In the liquid crystal display according to the first aspect of the invention, preferably one of the substrates includes the bank layer, and the other substrate includes the protrusion. Accordingly, the inclined directions of the liquid crystal molecules at the absence of an electric field are substantially identical over the entire liquid crystal layer, leading to a high quality display without unevenness of display with rough spots.

According to a second aspect of the present invention, an electronic device can include the liquid crystal display described above. The electronic device is provided with the display in which the orientation of the liquid crystal molecules can be controlled over the entire liquid crystal display, leading to a high quality display without unevenness of display with rough spots.

### BRIEF DESCRIPTION OF THE DRAWINGS

The invention will be described with reference to the accompanying drawings, wherein like numerals reference like elements, and wherein:

FIG. 1 is an equivalent circuit diagram of a liquid crystal display according to a first exemplary embodiment;

FIG. 2 is a partial perspective view of a display region of the liquid crystal display according to the first exemplary embodiment;

FIG. 3 is a cross-sectional view taken along line A-A in FIG. 2;

FIG. 4 is a plan view of one pixel;

FIG. 5 is a cross-sectional view of a liquid crystal display according to a second exemplary embodiment; and

FIG. 6 is a perspective view of a cellular phone according to the invention.

### DETAILED DESCRIPTION OF PREFERRED EMBODIMENTS

Exemplary embodiments of the invention will now be described by referring to the accompanying drawings. In the drawings, dimensions of components are appropriately modified for visual understanding. In each component of a liquid crystal display, the side close to a liquid crystal layer is referred to as an inner surface, and the side remote from the liquid crystal layer is referred to as an outer surface in the following description.

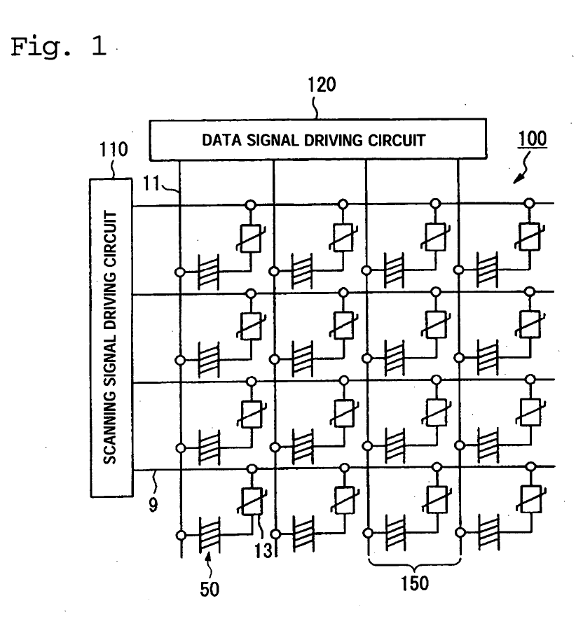

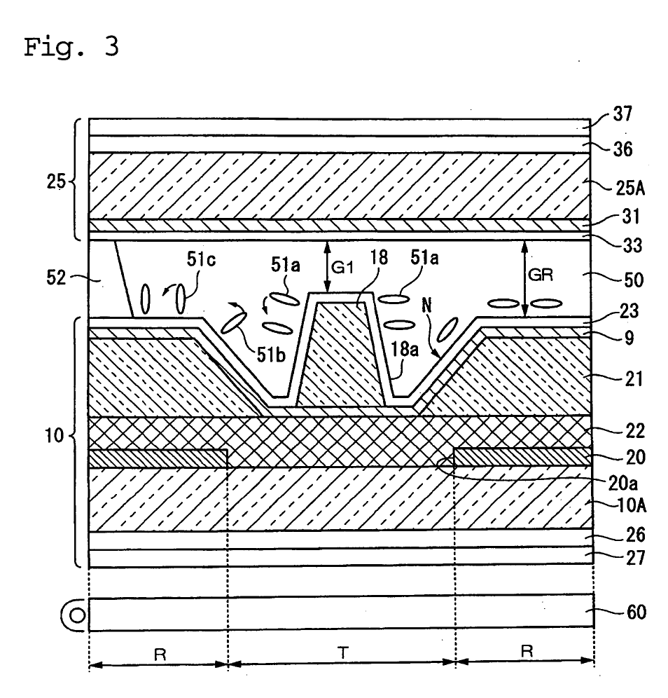

A liquid crystal display according to a first exemplary embodiment of the invention will now be described by referring to FIGS. 1 to 4. Referring to FIG. 3, a liquid crystal display 100 of the embodiment is a transreflective liquid crystal display and includes a pair of substrates including a bottom substrate 10 and a top substrate 25, and a liquid crystal layer 50. The liquid crystal layer 50 is composed of a liquid crystal material with negative dielectric anisotropy and is disposed between the bottom substrate 10 and the top substrate 25. The liquid crystal display 100 can further include a transmission display section T and a reflection display section R. The top substrate 25 is a switching element substrate (referred to as an element substrate hereinbelow), whereas the bottom substrate 10 is a color-filter substrate (referred to as a CF substrate hereinbelow). A protrusion 18 is disposed in the transmission display section T of the CF substrate 10. The liquid crystal display 100 is an active matrix liquid crystal display using a thin film diode (referred to as a TFD below) as a switching element. Alternatively, the invention may be applied to an active matrix liquid crystal display using a thin film transistor (TFT) as a switching element.

FIG. 1 is an equivalent circuit diagram of the liquid crystal display 100 according to the exemplary embodiment. A plurality of scanning lines 9 and a plurality of data lines 11 are arranged in a matrix in the liquid crystal display 100. The scanning lines 9 are driven by a scanning signal driving circuit 110 and data lines 11 are driven by a data signal driving circuit 120. A TFD element 13 and a liquid crystal display element or liquid crystal layer 50 are disposed at each intersection of the scanning lines 9 and the data lines 11. The TFD element 13 and the liquid crystal layer 50 are arranged in series between the scanning line 9 and the data line 11.

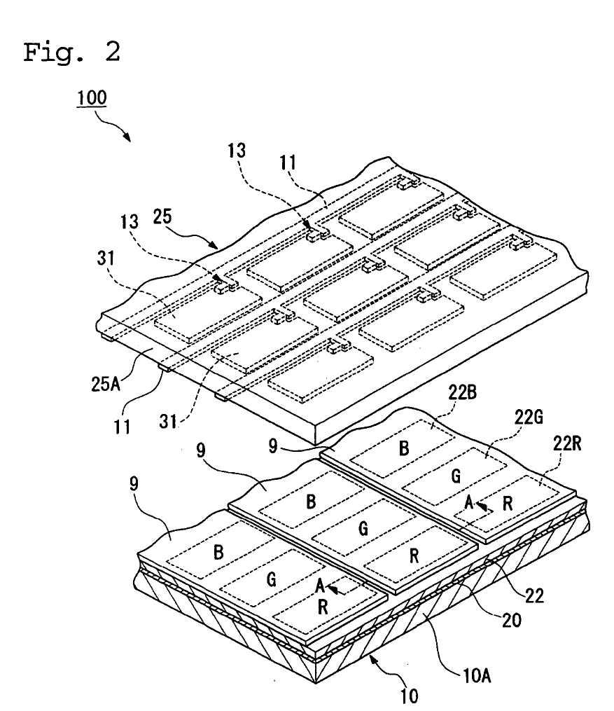

FIG. 2 is a partial perspective view of a display region of the liquid crystal display 100 according to the exemplary embodiment. The liquid crystal display 100 of the embodiment can include the element substrate 25 and the CF substrate 10 that oppose each other. The liquid crystal layer 50 shown in FIG. 3 is disposed between the CF substrate 10 and the element substrate 25. The liquid crystal layer 50 is composed of liquid crystal which has negative dielectric anisotropy and is initially aligned perpendicular to the substrates.

The element substrate 25 can include a substrate body 25A composed of a material that transmits light, such as glass, plastic, or quartz. The data lines 11 are strips and are disposed on the inner surface of the substrate body 25A (below the substrate body 25A in the drawing). Pixel electrodes 31 are disposed in a matrix on the inner surface of the substrate body 25A. The pixel electrodes 31 have substantially rectangular shapes when viewed from the top and are composed of transparent conductive material such as indium tin oxide (ITO). The TFD elements 13 connect the pixel electrodes 31 to the data lines 11. Each of the TFD elements 13 has a metal-insulator-metal (MIM) structure and consists of a first conductive film, an insulating film, and a second conductive film. The first conductive film is chiefly composed of Ta and is disposed on top of the element substrate 25. The insulating film is mainly composed of Ta₂O₃ and is disposed on top of the first conductive film. The second conductive film is mainly composed of Cr and is disposed on top of the insulating film. The first conductive films are connected to the respective data lines 11, whereas the second conductive films are connected to the respective pixel electrodes 31. The TFD element 13 functions as a switching element for controlling the supply of electrical current to the pixel electrodes 31.

The CF substrate 10 includes a substrate body 10A composed of a material that transmits light, such as glass, plastic, or quartz. A color filter layer 22 and the scanning lines 9 are disposed on the inner surface of the substrate body 10A (above the substrate body 10A). Color filters 22R, 22G, and 22B having substantially rectangular shapes are disposed periodically in the color filter layer 22 when viewed from the top. The color filters 22R, 22G, and 22B correspond to the respective pixel electrodes 31 of the element substrate 25. The stripe scanning lines 9 are composed of a transparent conductive material, such as ITO, and extend in a direction orthogonal to the data lines 11 of the element substrate 25. The scanning lines 9 cover the color filters 22R, 22G, and 22B disposed in the direction along which the scanning lines 9 extend and function as counter electrodes. The scanning line 9 is occasionally referred to as a counter electrode in the following description. One dot consists of a single pixel electrode 31 and one pixel consists of three dots including the color filters 22R, 22G, and 22B.

FIG. 3 is a cross-sectional view taken along line A-A in FIG. 2. For facilitating understanding, TFD elements and wiring in the element substrate 25 are not illustrated in FIG. 3. A reflective film 20 composed of, e.g., a metal film with high reflectance, such as aluminum or silver, is disposed on the inner surface of the substrate body 10A in the CF substrate 10. An opening 20a can be disposed in the reflective film 20 in a portion corresponding to the center region of the pixel electrode 31. The region where both the pixel electrode 31 and the reflective film 20 reside is a reflection display section R, whereas the region where both the pixel electrode 31 and the opening 20a reside is a transmission display section T.

A bank layer 21 composed of insulating material, such as acrylic resin is disposed on the inner surface of the color filter layer 22. The bank layer 21 adjusts the thickness of the liquid crystal layer. The bank layer 21 corresponds to the reflective film 20 and has a thickness ranging from 0.5 μm to 2.5 μm, for example. By the provision of the bank layer 21, the thickness of the liquid crystal layer 50 in the reflection display section R is about half of the thickness of the liquid crystal layer 50 in the transmission display section T, and thus the liquid crystal layer 50 has a multi-gap structure. An inclined region of the bank layer 21 is disposed in the border region between the reflection display section R and the transmission display section T. By the provision of the inclined region, the thickness of the liquid crystal layer 50 is continuously changed from the reflection display section R to the transmission display section T. The inclination angle of the inclined region is approximately 10° to 30° in general in the multi-gap structure.

The counter electrode 9 is disposed on the inner surface of the bank layer 21. An orientation film 23 composed of polyimide is disposed on the inner surface of the counter electrode 9. An orientation film 33 composed of polyimide is disposed on the inner surface of the pixel electrode 31 in the element substrate 25. Vertical alignment treatment is applied to the orientation film 23 and the orientation film 33 but treatment imparting pretilt such as rubbing is not applied thereto.

The liquid crystal layer 50 composed of a liquid crystal material having negative dielectric anisotropy can be disposed between the element substrate 25 and the CF substrate 10. In this liquid crystal material, liquid crystal molecules 51 are aligned perpendicular to the orientation film in the absence of an electric field, whereas the liquid crystal molecules 51 are aligned parallel to the orientation film, namely perpendicular to the direction of the electric field, in the present of an electric field, as conceptually illustrated in FIG. 3. The element substrate 25 and the CF substrate 10 are bonded to each other with seals (not shown) applied to the peripheries of the element substrate 25 and the CF substrate 10. The liquid crystal layer 50 is sealed in the area enclosed by the element substrate 25, the CF substrate 10, and the seals. An upright photo-spacer 52 disposed on the CF substrate 10 abuts the element substrate 25 and defines the thickness of the liquid crystal layer 50 (cell gap).

A retardation film 36 and a polarizer 37 are disposed on the outer surface of the element substrate 25, and a retardation film 26 and a polarizer 27 are disposed on the outer surface of the CF substrate 10. The polarizer 27 and the polarizer 37 selectively transmit linearly polarized light oscillating in a particular direction. Each of the retardation film 26 and the retardation film 36 is a λ/4 plate having a phase difference of substantially ¼ of the wavelength of visible light. The angle defined by the transmission axis of the polarizer 27 and the slow axis of the retardation film 26 is approximately 45°. Also, the angle defined by the transmission axis of the polarizer 37 and the slow axis of the retardation film 36 is approximately 45°. The polarizers 27 and 37 and the retardation films 26 and 36 constitute circular polarizers. These circular polarizers convert linear polarization to circular polarization and vice versa. The transmission axis of the polarizer 27 and that of the polarizer 37 are orthogonal to each other, and the slow axis of the retardation film 26 and that of the retardation film 36 are orthogonal to each other. A back light (illuminating device) 60 having a light source, a reflector, a light-guide plate and the like is disposed below the outer surface of the CF substrate 10, that is, outside of the liquid crystal cell.

The liquid crystal display 100 of a transreflective type shown in FIG. 3 displays an image in the following manner. Light from above the element substrate 25 is incident on the reflection display section R. The incident light then passes through the polarizer 37 and the retardation film 36 and is converted into circularly polarized light. This circularly polarized light then enters and traverses the liquid crystal layer 50. The light remains circularly-polarized while passing though the liquid crystal layer 50 because the liquid crystal molecules, which are aligned perpendicular to the substrate in the absence of an electric field, do not have anisotropy of refractive index. After that, the light is reflected by the reflective film 20 and reenters the retardation film 36. The light having passed again through the retardation film 36 is converted into linearly polarized light orthogonal to the transmission axis of the polarizer 37. The polarizer 37 will not transmit this linearly polarized light. On the other hand, light from the back light 60 enters the transmission display section T. The light passes through the polarizer 27 and the retardation film 26 and is converted into circularly polarized light. The light passes through the liquid crystal layer 50 and then enters the retardation film 36. The light having passed through the retardation film 36 is converted into linearly polarized light orthogonal to the transmission axis of the polarizer 37. The polarizer 37 will not transmit this linearly polarized light. Accordingly, the liquid crystal display 100 of the present embodiment performs black display when an electric field is not applied (normally black mode).

When an electric field is applied to the liquid crystal layer 50, the liquid crystal molecules are re-aligned parallel to the substrate and exhibit anisotropy of refractive index. Therefore, circularly polarized light incident on the liquid crystal layer 50 in the reflection display section R and the transmission display section T is converted into elliptical polarization when passing though the liquid crystal layer 50. The elliptical polarization passes through the retardation film 36. This light having passed through the retardation film 36 will not be converted into linearly polarized light orthogonal to the transmission axis of the polarizer 37, and all of or part of the light passes through the polarizer 37. Accordingly, the liquid crystal display 100 of the exemplary embodiment performs white display when an electric field is applied. Gradation display may be performed by adjusting the voltage applied to the liquid crystal layer 50.

As described above, the liquid crystal layer 50 transmits incident light twice in the reflection display section R but transmits the incident light once in the transmission display section T. Therefore, the retardation (phase difference) in the reflection display section R differs from that in the transmission display section T in the liquid crystal layer 50. This causes different transmittance in the reflection display section R and the transmission display section T, resulting in unevenness of display. However, since the bank layer 21 is disposed in the liquid crystal display 100 of the present embodiment, the retardation can be adjusted in the reflection display section R. Hence, display is homogeneous between the reflection display section R and the transmission display section T.

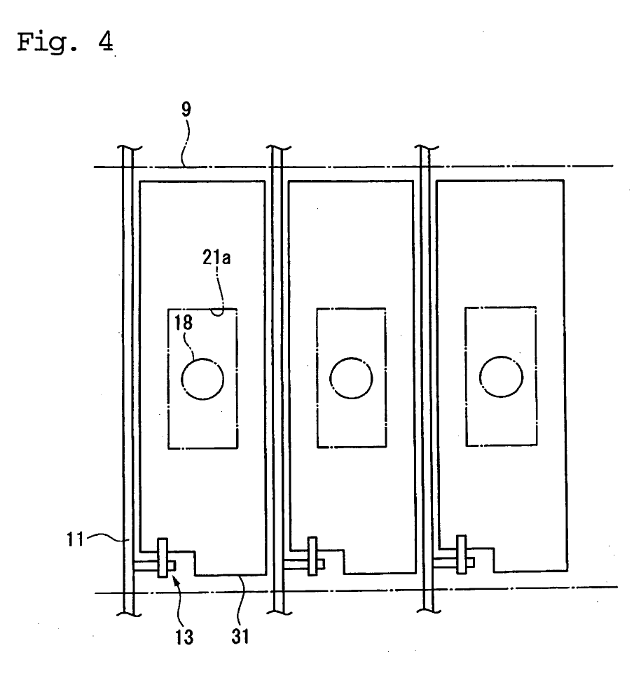

FIG. 4 is a plan view of one pixel in the liquid crystal display 100 shown in FIG. 2. Components of the element substrate 25 are shown in solid lines and components of the CF substrate 10 are shown in dotted-dashed lines. Each opening 20a in the reflective films 20 is disposed in the region corresponding to the center region of each pixel electrode 31. The opening 20a defines the transmission display section T. The protrusion 18 is disposed in the center region of each transmission display section T. The protrusion 18 is formed by lithography with dielectric material, such as resin. The protrusion 18 is substantially frusto-conical, frusto-pyramidal, or hemispherical when viewed from the top. The orientation film 23 is disposed on the protrusion 18, as shown in FIG. 3. According to the liquid crystal display 100 of the first exemplary embodiment, the protrusion 18 can be disposed on the inner surface of the counter electrode 9 in the CF substrate 10 including the bank layer 21. The protrusion 18 and the bank layer 21 are formed by lithography in predetermined relative positions, thereby ensuring the relative orientation of the liquid crystal in a pixel. Alternatively, a member for controlling the orientation of the liquid crystal molecules, such as a protrusion or slit, may also be provided in the pixel electrode 31.

The height of the protrusion 18 is larger than that of the bank layer 21, as shown in FIG. 3. Therefore, a thickness GI of the liquid crystal layer 50 in the region where the protrusion 18 is disposed (protrusion formation region) is smaller than a thickness GR of the liquid crystal layer 50 in the reflection display section R. In other words, the inner surface of the orientation film 23 in the protrusion formation region is closer to the element substrate 25 than the inner surface of the orientation film 23 in the reflection display section R. Furthermore, the protrusion 18 is tapered off from the CF substrate 10 toward the element substrate 25 and has a peripheral surface or an inclined surface 18a. An inclined region N of the bank layer 21 is disposed in the border region between the reflection display section R and the transmission display section T. The inclination angle of the inclined surface 18a in the protrusion 18 is larger than that of the inclined region N in the bank layer 21.

The operation of the protrusion 18 will now be described by referring to FIG. 3. In FIG. 3, the left side of the protrusion 18 shows the orientation of the liquid crystal molecules in the absence of an electric field, whereas the right side of the protrusion 18 shows the orientation of the liquid crystal molecules in the presence of an electric field.

Since the orientation film 23 is disposed on the protrusion 18, the liquid crystal molecules 51a disposed in the vicinity of the protrusion 18 are aligned perpendicular to the inclined surface 18a of the protrusion 18 in the absence of an electric field. Application of a voltage to the pixel electrode 31 and the counter electrode 9 generates an electric field perpendicular to the CF substrate 10 and the element substrate 25. Accordingly, in the absence of the electric field, the liquid crystal molecules 51a have predetermined pretilt angles with respect to the electric field, whereby the liquid crystal molecules 51a are tilted in the direction shown by the arrow in the drawing when an electric field is applied. Thus, the liquid crystal molecules 51a are aligned, as shown in the right side of the protrusion 18 in FIG. 3. More specifically, the liquid crystal molecules 51a are aligned radially with the protrusion 18 at the center when viewed from the top. In this way, a number of directors of the liquid crystal molecules are created, so that liquid crystal display 100 provides a wide viewing angle.

The orientation film 23 is disposed on the inclined region N of the bank layer 21. Liquid crystal molecules 51b disposed in the vicinity of the inclined region N are aligned perpendicular to the inclined region N in the absence of an electric field. Because the counter electrode 9 is disposed on the inclined region N, the electric field in the vicinity of the counter electrode 9 in the inclined region N is not perpendicular to the CF substrate 10 and the element substrate 25. Accordingly, with a known liquid crystal display, it is difficult to control the orientation of liquid crystal molecules in the vicinity of the inclined region N of the bank layer 21, resulting in difficulty in orientation control in the transmission display section T and the reflection display section R.

According to the exemplary embodiment, the liquid crystal molecules 51a disposed in the vicinity of the protrusion 18 are tilted in a predetermined direction by applying an electric field and subsequently the liquid crystal molecules 51b disposed in the vicinity of the inclined region N in the bank layer 21 are consecutively tilted in the direction designated by the arrow in the drawing, like domino toppling. Specifically, according to the present embodiment, since the height of the protrusion 18 is larger than that of the bank layer 21, all the liquid crystal molecules 51b disposed in the vicinity of the inclined region N are tilted in the predetermined direction.

As the inclination angle of the inclined surface 18a of the protrusion 18 increases, the orientation of the liquid crystal molecules 51a becomes closer to parallel to the CF substrate 10 and the element substrate 25 in the absence of an electric field. Therefore, the large inclination angle of the inclined surface 18a ensures the tilt of the liquid crystal molecules 51a when an electric field is applied. Accordingly, as the inclination angle of the protrusion 18 increases, the orientation control over the liquid crystal molecules becomes superior. When the inclination angle of the inclined surface 18a of the protrusion 18 is larger than the inclination angle of the inclined region N of the bank layer 21, tilt of the liquid crystal molecules 51b in the predetermined direction is ensured. In this manner, the irregularity of the orientation of the liquid crystal is eliminated in the inclined region N in the multi-gap structure.

Liquid crystal molecules 51c disposed in the vicinity of the flat surface of the bank layer 21 in the reflection display section R are aligned perpendicular to the CF substrate 10 and the element substrate 25 in the absence of an electric field. When a voltage is applied to the pixel electrode 31 and the counter electrode 9, an electric field perpendicular to the CF substrate 10 and the element substrate 25 is generated. According to a known liquid crystal display, the liquid crystal molecules 51c are randomly tilted and the orientation of the liquid crystal molecules 51c cannot be controlled.

According to the exemplary embodiment, the height of the protrusion 18 is larger than that of the bank layer 21. Therefore, application of an electric field tilts the liquid crystal molecules 51a disposed in the vicinity of the tip of the protrusion 18 in the predetermined direction, and, in turn, the liquid crystal molecules 51c disposed in the reflection display section R are tilted in the direction shown by the arrow in the drawing, like domino toppling. As described above, all of the liquid crystal molecules 51b in the vicinity of the inclined region N are tilted in the predetermined direction so that the liquid crystal molecules 51c are tilted in the predetermined direction. Specifically, since the inclination angle of the inclined surface 18a of the protrusion 18 is larger than the inclination angle of the inclined region N in the bank layer 21, the liquid crystal molecules 51c are precisely tilted in the predetermined direction.

As described above, in the liquid crystal display 100 of the exemplary embodiment, the orientation of the liquid crystal molecules is controlled not only in the transmission display section T including the protrusion 18 but also in the inclined region N of the bank layer 21 disposed in the border region between the transmission display section T and the reflection display section R and in the reflection display section R. That is, the orientation of the liquid crystal molecules is controlled across the entire liquid crystal layer 50. Hence, the occurrence of unevenness of display with rough spots is prevented, leading to a liquid crystal display exhibiting superior display quality.

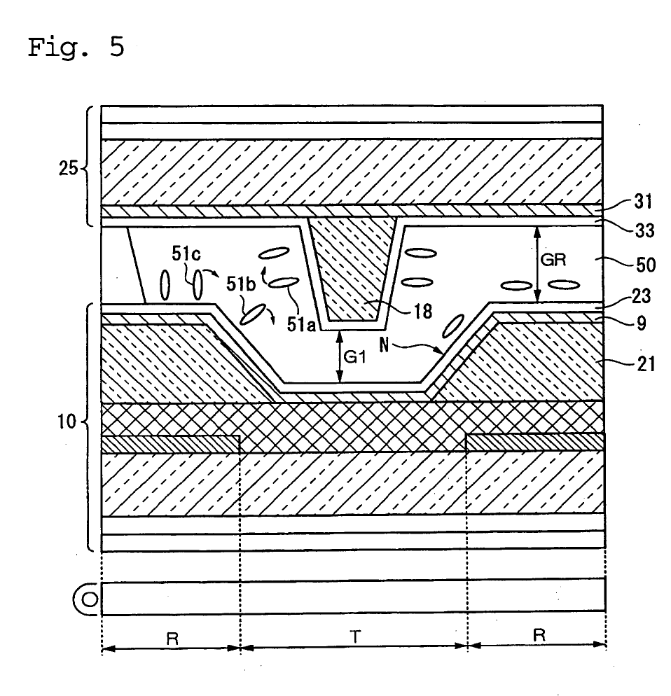

Referring to FIG. 5, a liquid crystal display according to a second exemplary embodiment of the invention will now be described. FIG. 5 is a cross-sectional view taken along line A-A in FIG. 2. The protrusion 18 is disposed on the element substrate 25 opposite to the CF substrate 10 including the bank layer 21 in the liquid crystal display according to the second embodiment, as shown in FIG. 5. The same components as those of the first exemplary embodiment will not be described here.

The protrusion 18 is disposed on the inner surface of the pixel electrode 31 in the element substrate 25, as shown in FIG. 5. The protrusion 18 is disposed in the center region of the transmission display section T. The height of the protrusion 18 is larger than that of the bank layer 21 whereby the thickness GI of the liquid crystal layer 50 in the protrusion formation region is smaller than the thickness GR of the liquid crystal layer 50 in the reflection display section R. The inner surface of the orientation film 33 in the protrusion formation region is lower than the inner surface of the orientation film 23 in the reflection display section R in the drawing. The inclination angle of the inclined surface 18a of the protrusion 18 is larger than that of the inclined region N of the bank layer 21. Alternatively, a member for controlling the orientation of the liquid crystal molecules, such as a protrusion or slit, may also be provided in the counter electrode 9.

The operation of the protrusion 18 will now be described by referring to FIG. 5. In FIG. 5, the left side of the protrusion 18 shows the orientation of the liquid crystal molecules when an electric field is not applied, whereas the right side of the protrusion 18 shows the orientation of the liquid crystal molecules when an electric field is applied.

Since the orientation film 33 is disposed on the protrusion 18, the liquid crystal molecules 51a are aligned perpendicular to the inclined surface 18a of the protrusion 18 in the absence of an electric field. On the other hand, since the orientation film 23 is disposed on the inner surface of the inclined region N in the bank layer 21, the liquid crystal molecules 51b are aligned perpendicular to the inclined region N in the absence of an electric field. The direction of the orientation of the liquid crystal molecules 51a is substantially identical to that of the liquid crystal molecules 51b. According to the second exemplary embodiment, since the protrusion 18 is disposed in the element substrate 25 opposite to the CF substrate 10 including the bank layer 21, the tilted direction of the liquid crystal molecules is substantially the same over the entire liquid crystal layer 50 in the absence of an electric field. Accordingly, the liquid crystal display of the second embodiment offers high quality uniform display.

Application of a voltage to the pixel electrode 31 and the counter electrode 9 generates an electric field perpendicular to the CF substrate 10 and the element substrate 25. Therefore, in the presence of the electric field, the liquid crystal molecules 51a are tilted in the direction shown by the arrow in the drawing and, in turn, the liquid crystal molecules 51b are tilted in the direction shown by the arrow in the drawing, like domino toppling. According to the exemplary embodiment, since the height of the protrusion 18 is larger than that of the bank layer 21, all of the liquid crystal molecules 51b in the vicinity of the inclined region N are tilted in a predetermined direction. Furthermore, since the inclination angle of the inclined surface 18a of the protrusion 18 is larger than the inclination angle of the inclined region N in the bank layer 21, the liquid crystal molecules 51c are precisely tilted in the predetermined direction.

The tilt of the liquid crystal molecules 51a in the predetermined direction, in turn, tilts the liquid crystal molecules 51c in the direction shown by the arrow in the drawing, like domino toppling. That is, the tilted liquid crystal molecules 51b in the predetermined direction tilts the liquid crystal molecules 51c in a predetermined direction. Furthermore, since the inclination angle of the inclined surface 18a of the protrusion 18 is larger than the inclination angle of the inclined region N in the bank layer 21, the liquid crystal molecules 51c are precisely tilted in the predetermined direction.

As described above, according to the liquid crystal display of the second embodiment, the orientation of the liquid crystal molecules is controlled over the entire liquid crystal layer 50. Accordingly, the liquid crystal display offers high quality display, eliminating the unevenness of display with rough spots.

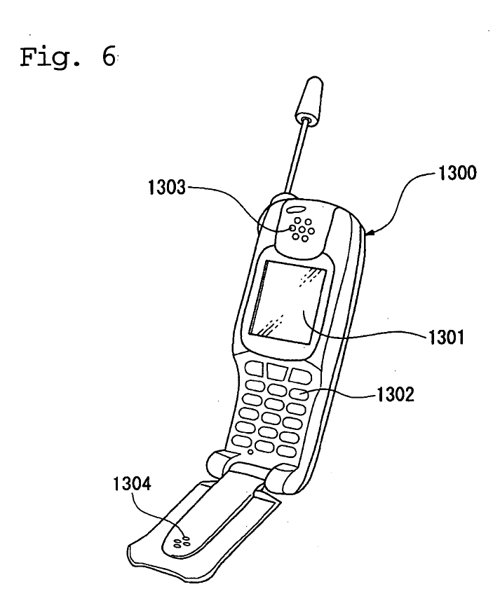

FIG. 6 is a perspective view of an example of an electronic device according to the invention. A cellular phone 1300 shown in FIG. 6 can include a display 1301, which is a miniaturized liquid crystal display of the present invention, a plurality of operating buttons 1302, a sound-receiving member 1303, and a sound-transmitting member 1304.

The liquid crystal displays according to the first and second exemplary embodiments of the invention may also be advantageously employed as image display device in electronic devices, such as an electronic book, personal computer, digital still camera, liquid crystal television, VCR with a viewfinder, VCR with a direct-view-type monitor, car navigation device, pager, electronic databook, calculator, word processor, workstation, picture phone, POS terminal, device with a touch panel, and the like. In these electronic devices also, the display device can attain wide viewing angles and a bright, high-contrast display.

It should be understood that the present invention is not to be limited to the above-described embodiments and includes modifications of the exemplary embodiments within the scope of the invention. Materials and structures exemplified in the embodiments may be modified, as the case may be.

The orientation of liquid crystal and the occurrence of unevenness of display were observed in the liquid crystal display of the first embodiment shown in FIG. 3 with different heights of the protrusion 18. In example 1, the height of the bank layer 21 was fixed to 2.0 μm, and the heights of the protrusion 18 were 1.4 μm, 1.8 μm, and 2.2 μm.

According to the protrusion 18 with a height of 1.4 μm, the orientation of the liquid crystal was disturbed in the inclined region N. This affected the orientation of the liquid crystal in the transmission display section T and the reflection display section R, resulting in unevenness of display with rough spots. According to the protrusion 18 with a height of 1.8 μm, though less, a similar unevenness of display was observed. By contrast, according to the protrusion 18 with a height of 2.2 μm, no irregular orientation of the liquid crystal was observed in the inclined region N and the liquid crystal was uniformly aligned, thereby preventing the unevenness of display.

The results show that according to the liquid crystal display of the first embodiment, making the height of the protrusion 18 larger than that of the bank layer 21 can eliminate the irregularity of the orientation of the liquid crystal in the inclined region N in the multi-gap structure, thereby preventing unevenness of the display.

The orientation of liquid crystal and the occurrence of unevenness of display were observed in the liquid crystal display of the first exemplary embodiment shown in FIG. 3 with different heights of the bank layer 21. In example 2, the height of the protrusion 18 was fixed to 2.1 μm, and the heights of the bank layer 21 were 2.0 μm, 2.3 μm, and 2.5 μm.

According to the bank layer 21 with a height of 2.5 μm, the orientation of the liquid crystal was disturbed in the inclined region N. This affected the orientation of the liquid crystal in the transmission display section T and the reflection display section R, resulting in unevenness of display with rough spots. According to the bank layer 21 with a height of 2.3 μm, though less, a similar unevenness of display was observed. By contrast, according to the bank layer 21 with a height of 2.0 μm, no irregular orientation of the liquid crystal molecules was observed in the inclined region N, and the liquid crystal was uniformly aligned, thereby preventing the unevenness of display.

The results show that according to the liquid crystal display of the first embodiment, making the height of the bank layer 21 smaller than that of the protrusion 18 can eliminate the irregularity of the orientation of the liquid crystal in the inclined region N in the multi-gap structure, thereby preventing the unevenness of the display.

The orientation of liquid crystal and the occurrence of unevenness of display were observed in the liquid crystal display of the second embodiment shown in FIG. 5 with different heights of the protrusion 18. In example 3, the height of the bank layer 21 was fixed to 2.0 μm, and the heights of the protrusion 18 were 1.4 μm, 1.8 μm, and 2.2 μm.

According to the protrusion 18 with a height of 1.4 μm, the orientation of the liquid crystal was disturbed in the inclined region N. This affected the orientation of the liquid crystal in the transmission display section T and the reflection display section R, resulting in unevenness of display with rough spots. According to the protrusion 18 with a height of 1.8 μm, though less, a similar unevenness of display was observed. By contrast, according to the protrusion 18 with a height of 2.2 μm, no irregular orientation of the liquid crystal was observed in the inclined region N and the liquid crystal was uniformly aligned, thereby preventing the unevenness of display.

The results show that according to the liquid crystal display of the second embodiment, making the height of the protrusion 18 larger than that of the bank layer 21 can eliminate the irregularity of the orientation of the liquid crystal in the inclined region N in the multi-gap structure, thereby preventing the unevenness of the display.

The orientation of liquid crystal and the occurrence of unevenness of display were observed in the liquid crystal display of the second embodiment shown in FIG. 5 with different heights of the bank layer 21. In example 4, the height of the protrusion 18 was fixed to 2.1 μm, and the heights of the bank layer 21 were 2.0 μm, 2.3 μm, and 2.5 μm.

According to the bank layer 21 with a height of 2.5 μm, the orientation of the liquid crystal was disturbed in the inclined region N. This affected the orientation of the liquid crystal in the transmission display section T and the reflection display section R, resulting in unevenness of display with rough spots. According to the bank layer 21 with a height of 2.3 μm, though less, a similar unevenness of display was observed. By contrast, according to the bank layer 21 with a height of 2.0 μm, no irregular orientation of the liquid crystal was observed in the inclined region N, and the liquid crystal was uniformly aligned, thereby preventing the unevenness of display.

The results show that according to the liquid crystal display of the second embodiment, making the height of the bank layer 21 smaller than that of the protrusion 18 can eliminate the irregularity of the orientation of the liquid crystal in the inclined region N in the multi-gap structure, thereby precisely preventing the unevenness of the display.

Further, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. A liquid crystal display, comprising:
a pair of substrates;
a liquid crystal layer interposed between the pair of substrates, the liquid crystal layer being composed of liquid crystal that has a negative dielectric anisotropy and that is initially aligned perpendicular to the substrates;
dot regions, each including a transmission display section and a reflection display section;
a bank layer that is disposed between at least one of the substrates and the liquid crystal layer that makes a thickness of the liquid crystal layer in the reflection display section smaller than a thickness of the liquid crystal layer in the transmission display section; and
a protrusion that is disposed between at least one of the substrates and the liquid crystal layer in the transmission display section of each dot region, the protrusion initially tilting an orientation of the liquid crystal, and a thickness of the liquid crystal layer in a region where the protrusion is disposed being smaller than the thickness of the liquid crystal layer in the reflection display section.

2. The liquid crystal display according to claim 1, a height of the protrusion being larger than a height of the bank layer disposed in the reflection display section.

3. The liquid crystal display according to claim 1, the bank layer including an inclined region, the inclined region being disposed in a border region between the transmission display section and the reflection display section, and the protrusion including an inclined surface, an inclination angle of the inclined surface being larger than an inclination angle of the inclined region of the bank layer.

4. The liquid crystal display according to claim 1, one of the substrates including the bank layer and the protrusion.

5. The liquid crystal display according to claim 1, one of the substrates including the bank layer, and the other substrate including the protrusion.

6. An electronic device, comprising:
the liquid crystal display as set forth in claim 1.
